(19) United States
(12) Patent Application Publication
(10) Pub. No.: US 2005/0048450 A1
(43) Pub. Date: Mar. 3, 2005

(54) Method and system for facilitating reading and writing without literacy

(76) Inventor: Andrew Max Winkler, Lower Saucon Township, PA (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/651,944

(22) Filed: Sep. 2, 2003

(51) Int. Cl. G09B 19/00; G09B 19/04

(52) U.S. Cl. 434/185; 434/156

(57) ABSTRACT

The present invention relates a communication media and method of communication which allows anyone to mutely create a representation of their language without requiring of them any prerequisite literacy or rote memorization. Further, the present invention relates to a process of presenting language to someone without requiring from them the ability to hear or requiring from them any prerequisite literacy or rote memorization. Finally, the present invention relates to other methods of utilizing this communication media to transfer written words and sounds of any nature from word to sounds and vice versa without requiring from them the ability to hear or requiring from them any prerequisite literacy or rote memorization.

### BACKGROUND OF INVENTION

1. Field of the Invention

The present invention relates a communication medium and method of communication which allows anyone to mutely create a representation of their language without requiring of them any prerequisite literacy or rote memorization. Further, the present invention relates to a process of presenting language to someone without requiring from them the ability to hear or requiring from them any prerequisite literacy or rote memorization. Finally, the present invention relates to other methods of utilizing this communication medium to transfer written words and sounds of any nature from word to sounds and vice versa without requiring from them the ability to hear or speak or requiring from them any prerequisite literacy or rote memorization.

2. Discussion of the Background

The advantages of writing, publishing, and reading are staggering. Every activity of the modern world relies heavily on those technologies. To gain some awareness of the magnitude, it is probably easiest to focus not on the value of literacy, but on the costs, which have been partially quantified, of illiteracy. A compilation of studies taken from “Illiterate America,” by Jonathan Kozol, as well as updated information reported in The Washington Post, the Associated Press, The Baltimore Sun, and The Salt Lake Tribune, drawing on a report of the Senate Select Committee on Equal Educational Opportunity, reported at www.literacy-research.com/answers.html, has concluded that the government spends 200 billion dollars every year in attempts to overcome illiteracy. Further, this study has concluded that the productivity losses, equipment destruction, accidents, etc that can be traced to illiteracy constitutes an additional 200 billion each year. Finally, there has been shown to be a direct relationship between the literacy level of prisoners on their release and their likelihood of returning to crime when released which enabled this study. Congress to quantify an additional 135 billion dollars in costs directly attributed to illiteracy each year of the total 450 billion dollar cost of crime. Therefore, the estimated cost to the United States has been calculated by this study as a staggering 435 billion per year, or about $1750 per person per year.

One can estimate the cost for other countries as well because there is a direct relationship between literacy level and income. Hence, in less literate countries the per capita cost of illiteracy is greater. This suggests a very conservative world cost of 7 trillion dollars every year due to illiteracy and less than full literacy.

Moreover, for the person who is even marginally illiterate, a broad world of activities is closed off, safety is infringed, and the need to feign literacy leads to dangers for others and accidental destruction of machinery. Yet, despite these obstacles to illiterate people and the staggering societal costs outlined above, efforts to reduce illiteracy by simply teaching illiterates to read and write in their native spoken language have made marginal progress at best. Indeed, the failure of these efforts is evidenced by the staggering costs itself. It is clear that an alternative method of combating illiteracy is needed.

### BRIEF DESCRIPTION OF THE FIGURES

FIG. 1: A process diagram exemplifying writing in English using the Whole Word Method for the word “smoothing”.

FIG. 2: A process diagram exemplifying reading in English using the Whole Word Method for the word “smoothing”.

FIG. 3: A process diagram exemplifying writing in English using the Phonetic Method for the word “smoothing”.

FIG. 4: A process diagram exemplifying reading in English using the Phonetic Method for the word “smoothing”.

FIG. 5: A process diagram exemplifying writing in English using the International Phonetic Alphabet for the word “smoothing”.

FIG. 6: A process diagram exemplifying reading in English using the International Phonetic Alphabet for the word “smoothing”.

FIG. 7: A process diagram exemplifying one embodiment of the present invention including how one may prepare to write the word “smoothing” in English using one embodiment of the present invention.

FIG. 8: A process diagram exemplifying reading and writing according to one embodiment, e.g. Level 1, of the present invention utilizing the word “smoothing”.

FIG. 9: A process diagram exemplifying reading and writing according to one embodiment, e.g. Level 3, of the present invention utilizing the word “smoothing”.

FIG. 10: A process diagram exemplifying how one may convert standard writing to one embodiment of the present invention utilizing the word “smoothing”.

FIG. 11: a computer system 1101.

### SUMMARY OF THE INVENTION

An objective of the present invention is to allow anyone to mutely create a representation of their language without requiring of them any prerequisite literacy or rote memorization.

Another objective of the present invention is to allow for the presentation of language to someone without requiring of them either the ability to hear or requiring of them any prerequisite literacy or rote memorization.

Yet another objective of the present invention is to allow the automatic acquisition of literacy, without requiring any prerequisite literacy, rote memorization, or access to electronic devices or already literate people.

Yet another objective of the present invention is to make available to everyone, regardless of their level of literacy, and without requiring of them any rote memorization of any symbols, all the activities which are available to literate people.

In one embodiment, a collection of objects is gathered. For the first word one wishes to express, one may select from a collection of some objects whose names contain the first sound of the word where the selected collection is large enough so that the common sound shared therein is unambiguous. One continues in this fashion until one has laid out a list of such collections. This provides, in part, for mute representation of language without requiring any literacy whatsoever of the person performing the writing. Moreover, the collection can be shown to anyone even modestly fluent in the corresponding language with no literacy requirement on that person whatever; thereby presenting language to them inaudibly.

To read back, one simply reverses the above-mentioned process by first examining the first collection of objects and then identifying the sound that the names for those objects have in common. This process can be repeated for each of the collections, fusing together in sequence the sounds that are in common within each individual collection, enabling the formation of syllables, words, and sentences. Alternatively, one can pre-select such a collection for each sound of the language.

For economy of effort, it is possible to reduce the collection chosen for expressing a particular sound to just one object therein. Most preferably, the name of the chosen object provides the desired sound as the first sound of the chosen object. While it would be convenient to always be able to just use one object, the typical structure of natural language does not allow for this situation at all times. In fact, some sounds are never used to start words or are so rarely used initially that those few words that do start with that sound are not objects that can be readily represented by an object (i.e. a recognizable symbol). For example, the sound common to “ring” and “tongue” is a palatal nasal, which is never the beginning sound of any English word. The sound common to both “treasure” and “collage” only occurs within English words that have been recently borrowed from other languages, principally the French language. The sound common to both “weather” and “bathe” is almost never found at the beginning of a word, except for demonstratives, such as “the”, “there”, “this”, and “that”, as well as archaic pronouns, such as “thou”, “thee”, “thy”, and “thine”. Such sounds we will call “obscure sounds”, to distinguish them from the “common sounds” which do occur frequently at the beginning of a word.

This method may be most useful for keeping the attention of children, while showing them how more economical versions of the method work.

In another embodiment, instead of actual objects, one may use representations of the objects, such as molded plastic toys, or carvings, or tiles or cards with pictures on them, or even ink stamps, all of which are less expensive and easier to manipulate than the actual objects themselves.

In yet another embodiment, those representations may be connected to some kind of sensor, such as a keyboard or touchscreen, for further processing, which could involve electromagnetic processing, analog or digital, or mechanical. For example, the representations could be mechanically linked to air valves, so that a distinct organ pipe plays for each selection. This representation then could be detected at a distance via objects having matching resonant frequencies to the pipe, for further conversion into other representations of language.

In yet another embodiment, a selection device is associated with those representations, as say images on a computer screen to be chosen by a mouse, or a detector of eye motion.

Within these embodiments, one may create a keyboard which replaces letters of the keyboard with the picture collections as described above. Moreover, one may provide a menu of those image collections on a computer screen to be selected by a mouse. It is also possible to utilize a chorded device, which provides a switch or button or proximity sensor for each finger where one utilizes different finger combinations to select for vowels, semivowels, consonants. Further, a finger may choose voicing or not, while another may choose aspiration or not. Still further, another three fingers or so may be utilized to choose a place of articulation, while another finger may be used to select nasality, and so on for the specific identified characteristics human speech. In the meantime, a computer screen may display the appropriate picture of combinations for that sound for the selected language.

It is also possible to automate the selection process, by converting the desired text into unicode either by producing it as described or by scanning printed text and performing optical character recognition on it. Further, automation may occur by direct conversion from some electronic or computer based form. The unicode text is then parsed into words. Each word may then be converted into the form described above by selecting or creating a number of pictures as described above for each sound of the language which one wishes to represent; thereby generating a phonetic engine for the language. A phonetic engine may be a processor capable of taking a selected word and producing the sounds which make up the selected word. In the case of languages with a regular orthography, such as Spanish, this engine can be readily created. In a more complicated case, such as English, a sizable table of exceptions to the algorithms which occasionally allow discerning the sounds from the spellings may be necessary. In the most complicated cases, such as Chinese, no algorithm is possible and the exception table contains the entire language. It is best to organize this phonetic engine in such a way that the syllabic divisions of the words are clear, so that the reader can be presented with the text in such a way as to make it easy to sound out the picture sequence, and so that any alphabetic writing is associated to the degree that it is meaningful with corresponding sounds, thereby providing the reader the means of acquiring the so-called phonic skills to the extent that the customary written form of the language makes that possible. Of course the occasional homograph may require human intervention. Phonetic dictionaries are generally available, and where they do not provide division into syllables, the rules identified by linguists may be used. The simple device of identifying the consonant clusters that occur at the beginning and at the end of words gives an indication that syllables are likely to end the same way words do, and begin the same way words do, and often that insight is enough to automate the process of dividing words into syllables.

To publish such a representation may be to either print the sequence of words onto a page or incorporate the sequence of words into an electronic image, each word being displayed with some combination of the typeset version of the word in classical written form, the sequence of collections for each sound of the word, and the typeset version of the individual pieces of the classical written form matched up with the corresponding sounds.

In a language written left to right, one may place the collection vertically, so that it is clear that all the pictures together pertain to one sound. One may also provide a visual separation between words and/or between syllables. Further, one may place the sound collections left to right, while having below each sound or possibly sequence of sounds the letter or possibly sequence of letters that it corresponds to, as well as the normal classical written form of the whole word. While not necessary, it may be best to also distinctively mark the vowel sounds of each syllable for ease of sound fusion. Still further, one may add directions for reading. Examples of directions for reading include signaling by arrows and having all of the objects face the same direction.

It would be extremely useful to have a form of mutely created representations of language, and an inaudibly presented language, so as to allow anyone to use such methods. Further, such a language will allow anyone to benefit from another's use of such methods, without requiring the whole or partial rote memorization of symbols.

It would also be extremely useful to have a means for teaching existing writing systems, with their enormous wealth of existing texts without incurring the enormous training costs which currently is required for currently existing writing systems and communication means.

### DETAILED DESCRIPTION OF THE INVENTION

One of the most important technologies in existence is the companion technologies of writing and reading. An example of such a companion technology may include means of representing language by mute means and means of reading. Such mute means and means of reading may be exemplified by the perception of language by deaf means. These technologies have been significantly improved over the years with the addition of publishing means. Examples of publishing means may include the presentation of language in a form suitable for reading. The phrase “silent communication” is meant in this application to mean any task involving writing or publishing.

Unless specifically defined, all technical and scientific terms used herein have the same meaning as commonly understood by a skilled artisan of communications, linguistics, psychology, and/or computer science.

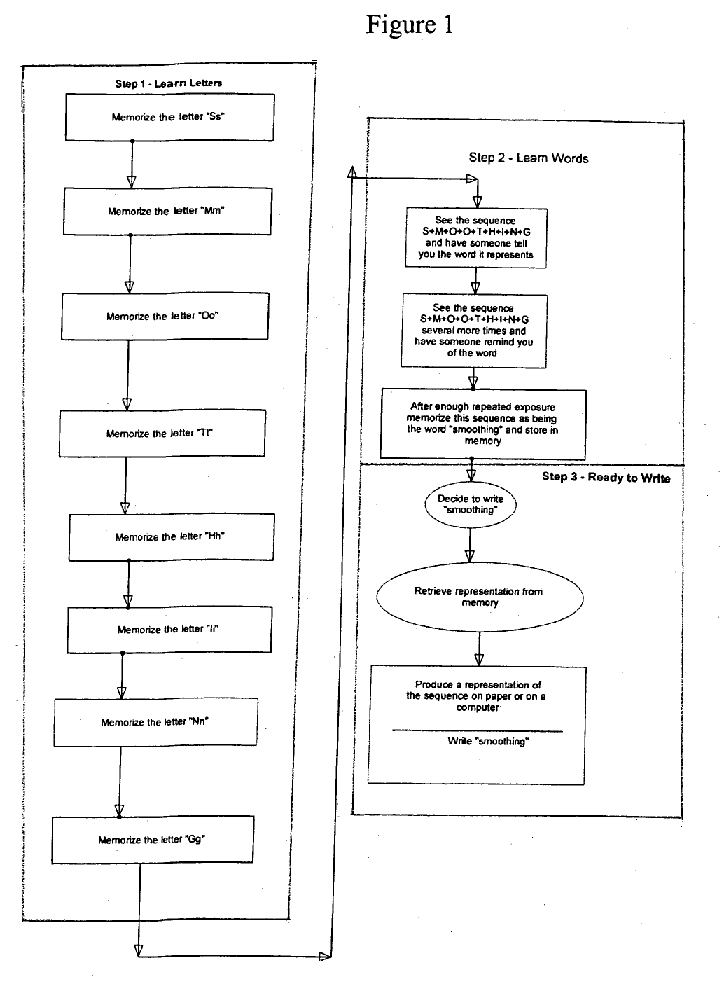

As noted in the Background Section above, increased efforts to teach reading, publishing and writing of existing language systems has failed to solve the literacy problem. The biggest hurdle to using existing systems for reading, publishing and writing is the enormous investment of training time that goes into learning to read and write by rote memorization (e.g. rote symbols) and/or by dependence on recognition of previously taught symbols (e.g. recognizable symbols). There are a number of different writing systems in use in the world, though for any one language, there is generally only one widely being used. Writing systems all use a sequence from some collection of commonly agreed upon pattern. For example, these patterns may be formed of ink on paper, of positions of the hands, of electrical pulses, for conveying language. Symbols must be painstakingly memorized via rote memorization. Further, arcane manipulation rules must be mastered or memorized via rote memorization. In one very common approach to reading, even whole words must be memorized by rote memorization. For many of the worlds' most important writing systems, rote memorization is, in fact, the only way such systems can be either wholly or partially learned. The enormous effort required to obtain literacy in a language such as English is best understood by the Exemplified current methods shown in FIGS. 1-6.

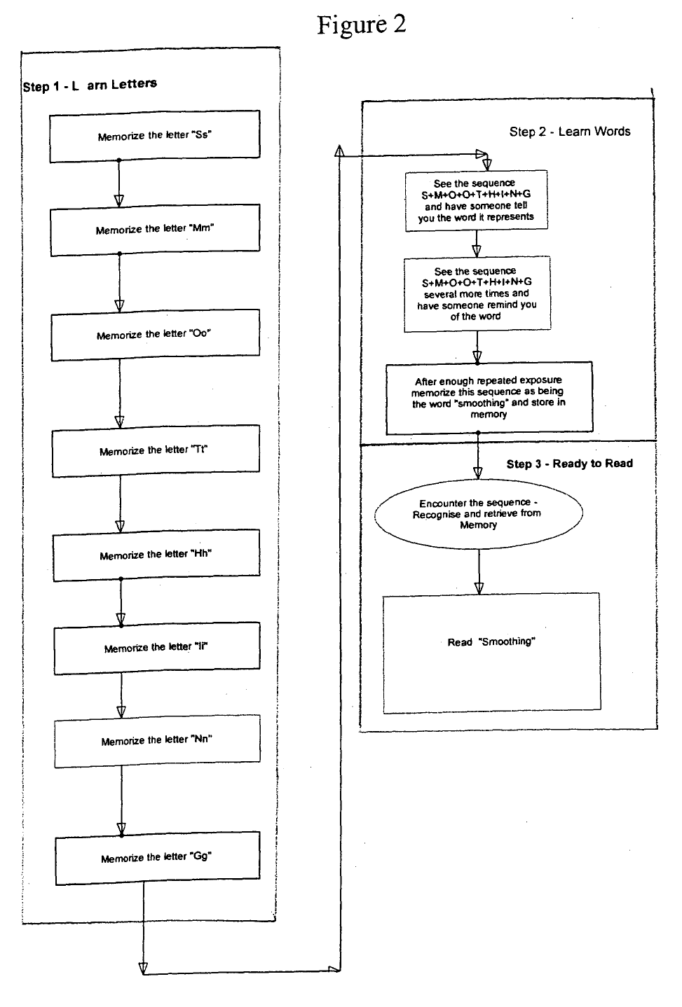

One method of obtaining literacy in English is the Whole World method. FIGS. 1 and 2 illustrate exemplary processes for learning to write and read an English word, respectively, using the Whole World method.

As seen in FIG. 1, Writing Using the Whole Word Method requires the following steps:

Step 1

Memorize the letter “Ss”.

Memorize the letter “Mm”.

Memorize the letter “Oo”.

Memorize the letter “Tt”.

Memorize the letter “Hh”.

Memorize the letter “Ii”.

Memorize the letter “Nn”.

Memorize the letter “Gg”.

Step 2

Memorize this sequence as being the word “smoothing”. This involves seeing the sequence S+M+O+O+T+H+I+N+G. Further, it involves having someone tell you the word it represents. Still further, it requires repeat exposure to the above-mentioned seeing of the sequence, as well as continual reminders from a second party that the particular sequence of letters S+M+O+O+T+H+I+N+G represents the word “smoothing”.

Step 3

Produce a representation of this sequence with a presentation device such as ink on paper or a computer driven display. This requires a cognitive decision to write “smoothing” and then a memory retrieval process of which sequence of letters actually represent “smoothing”.

As seen in FIG. 2, Reading Using the Whole Word Method requires the following steps:

Step 1

Memorize the letter “Ss”.

Memorize the letter “Mm”.

Memorize the letter “Oo”.

Memorize the letter “Tt”.

Memorize the letter “Hh”.

Memorize the letter “Ii”.

Memorize the letter “Nn”.

Memorize the letter “Gg”.

Step 2

Memorize this sequence as being the word “smoothing”. This involves seeing the sequence S+M+O+O+T+H+I+N+G. Further, it involves having someone tell you the word it represents. Still further, it requires repeat exposure to the above-mentioned seeing of the sequence, as well as continual reminders from a second party that the particular sequence of letters S+M+O+O+T+H+I+N+G represents the word “smoothing”.

Step 3

When this sequence is encountered, one is required to recognize it and retrieve it from memory in order to read the word “smoothing”.

Thus, as seen in FIGS. 1 and 2, to prepare to use the whole word method in a language one must first learn the characters which involves memorization of somewhere between a few dozen and 10's of thousands of pen stroke combinations. Once these symbols have been memorized, one must memorize combinations of these symbols which form actual words. In order to be able to perform this rote memorization, one must have excessive exposure to the words as well as some means of being told repeatedly what word that symbol represents, of course, these are substantial obstacles to obtaining literacy by way of the Whole World method.

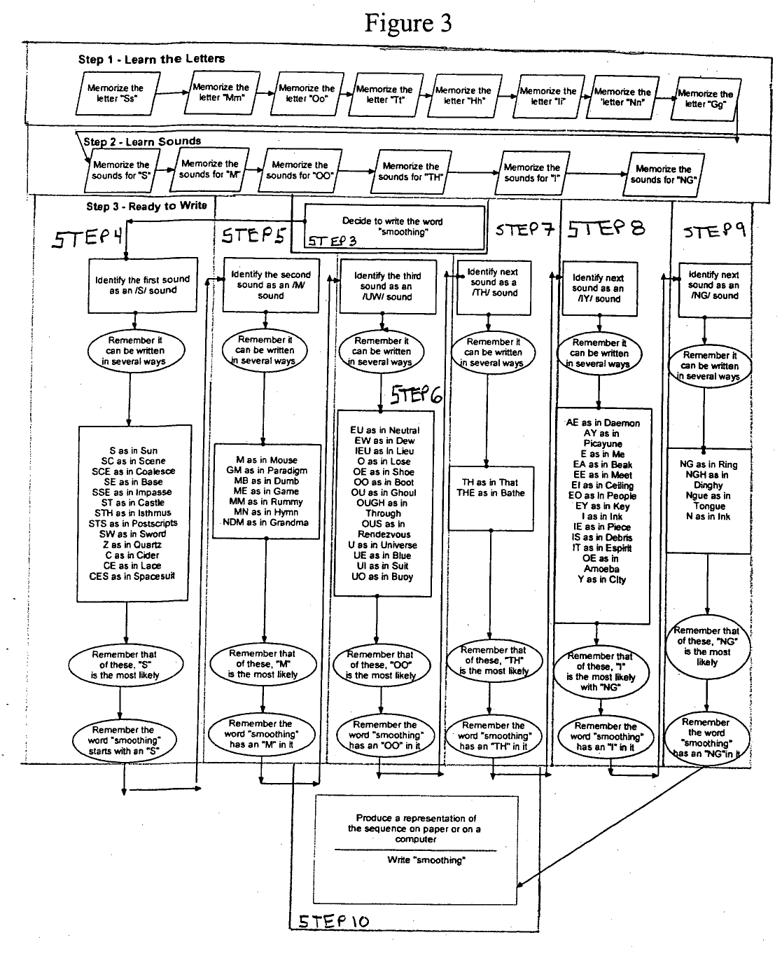

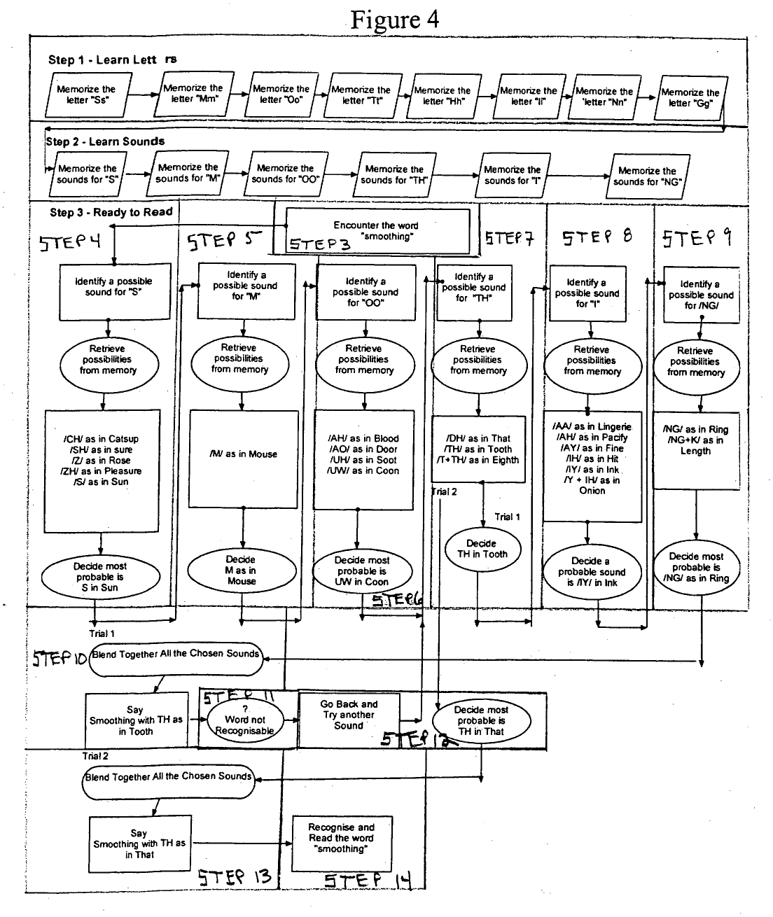

The Phonetic Method of obtaining literacy in a language is exemplified by FIGS. 3 and 4, which show process steps for learning to writing and reading in English respectively, using the Phonetic Method.

As seen in FIG. 3, Writing Using the Phonetic Method requires the following steps:

Step 1

Memorize the letter “Ss”.

Memorize the letter “Mm”.

Memorize the letter “Oo”.

Memorize the letter “Tt”.

Memorize the letter “Hh”.

Memorize the letter “Ii”.

Memorize the letter “Nn”.

Memorize the letter “Gg”.

Step 2

Memorize the sounds for the letter “Ss”.

Memorize the sounds for the letter “Mm”.

Memorize the sounds for the letter “Oo”.

Memorize the sounds for the letter “Tt”.

Memorize the sounds for the letter “Hh”.

Memorize the sounds for the letter “Ii”.

Memorize the sounds for the letter “Nn”.

Memorize the sounds for the letter “Gg”.

Step 3

Decide to write the word “smoothing”

Step 4

Identify the first sound as an /S/ sound. In English, this sound can be represented in the following ways:

S as in “sun”,

SC as in “scene”,

SCE as in “coalesce”,

SE as in “base”,

SS as in “lass”,

SSE as in “impasse”,

ST as in “castle”,

STH as in “isthmus”,

STS as in “postscripts”,

SW as in “sword”,

Z as in “quartz”,

C as in “cider”,

CE as in “lace”, and

CES as in “spacesuit”.

Then, remember that from among these that “S” is the most likely. Then, remember that every time one has seen the word “smoothing”, it has started with an “s”.

Step 5

Identify the next sound as an /M/ sound. In English, this sound can be represented in the following ways:

M as in “mouse”,

GM as in “paradigm”,

MB as in “dumb”,

ME as in “game”,

MM as in “rummy”,

MN as in “hymn”, and

NDM as in “grandma”

Then, remember that from among those that “M” is the most likely. Then, remember that every time one has seen the word “smoothing”, it has had the letter “m” in it.

Step 6

Identify the next sound as an /UW/ sound. In English this sound can be represented in the following ways:

EU as in “neutral”,

EW as in “dew”,

IEU as in “lieu”,

O as in “lose”,

OE as in “shoe”,

OO as in “boot”,

OU as in “ghoul”,

OUGH as in “through”,

OUS as in “rendezvous”,

U as in “universe”,

UE as in “blue”,

UI as in “suit”, and

UO as in “buoy”.

Then, remember that from among these that “OO” is the most likely. Then, remember that every time one has seen the word “smoothing”, it has had two “o's” in it.

Step 7

Identify the next sound as a /TH/ sound. In English, this sound can be represented in the following ways:

TH as in “that”, and

THE as in “bathe”.

Then, remember that from among these that “TH” is the most likely. Then, remember that every time one has seen the word “smoothing” it has had a “th” in it.

Step 8

Identify the next sound as an /IY/ sound. In English, this sound can be represented in the following ways:

AE as in “daemon”,

AY as in “picayune”,

E as in “me”,

EA as in “beak”,

EE as in “meet”,

EI as in “ceiling”,

EO as in “people”,

EY as in “key”,

I as in “ink”,

IE as in “piece”,

IS as in “debris”,

IT as in “esprit”,

OE as in “amoeba”, and

Y as in “city”.

Then, remember that from among these “I” is the most likely choice to combine with the next sequence of “ng”. Then, remember that every time one has seen the word “smoothing” it has had an “i” in it.

Step 9

Identify the final sound as an /NG/ sound. In English, this sound can be represented in the following ways:

NG as in “ring”,

NGH as in “dinghy”,

NGUE as in “tongue”, and

N as in “ink”.

Then, remember that from among these that “NG” is the most likely. Then, remember that every time one has seen the word “smoothing”, it has ended with “ng”.

Step 10

Produce a representation of this sequence with a presentation device such as ink on paper or a computer driven display.

FIG. 4 shows the process steps for Reading Using the Phonetic Method:

Step 1

Memorize the letter “Ss”.

Memorize the letter “Mm”.

Memorize the letter “Oo”.

Memorize the letter “Tt”.

Memorize the letter “Hh”.

Memorize the letter “Ii”.

Memorize the letter “Nn”.

Memorize the letter “Gg”.

Step 2

Memorize the sounds for the letter “Ss”.

Memorize the sounds for the letter “Mm”.

Memorize the sounds for the letter “Oo”.

Memorize the sounds for the letter “Tt”.

Memorize the sounds for the letter “Hh”.

Memorize the sounds for the letter “Ii”.

Memorize the sounds for the letter “Nn”.

Memorize the sounds for the letter “Gg”.

Step 3

One encounters the word “smoothing.

Step 4

Identify a possible sound for the letter “s” which could be any of the following:

CH as in “catsup”,

SH as in “sure”,

Z as in “rose”,

ZH as in “pleasure”, and

S as in “soup”.

Then, decide the most probable is the sound in “soup”

Step 5

Identify the sound for the letter “m” as M as in “mouse”

Step 6

Identify a possible sound for the letters “oo” which could be any of the following:

AH as in “blood”,

AO as in “door”,

H as in “soot”, and

UW as in “coon”.

Then, decide that a probable sound is the sound in “coon”

Step 7

Identify a possible sound for the letters “th” which could be any of the following:

TH as in “tooth”,

DH as in “that”, and

TH as in “eighth”.

Then, decide that a probable sound is the sound in “tooth”

Step 8

Identify a possible sound for the letter “I” which could be any of the following:

AA as in “lingerie”,

AH as in “pacify”,

AY as in “fine”,

IH as in “hit”,

IY as in “ink”, and

Y+IH as in “onion”.

Then, decide that a probable sound is the sound in “ink”.

Step 9

Identify a possible sound for the letters “ng” which could be:

NG as in “ring”, and

NG+K as in “length”.

Then, decide that a probable sound is the sound in “ring”.

Step 10

Blend all of these probable sound combinations together and produce the word “smoothing” having the /TH/ sound pronounced as in “tooth”.

Step 11

The word is not recognizable. The /TH/ sound is the incorrect choice.

Step 12

Go back and try some alternate sounds. Try the /DH/ sound as in “that” and decide it is the most probable sound.

Step 13

Blend all of these probable sound combinations together and produce the word “smoothing” having the /DH/ sound as pronounced in “that”.

Step 14

The word is recognized and read.

Thus, as seen in FIGS. 3 and 4, to prepare to use the phonetic method in a language, one must first learn the alphabet which involves memorization of somewhere between a few dozen and 10's of thousands of pen stroke combinations. Once these symbols have been memorized, one must learn the sounds the letters can represent and then learn combinations of letters and the sounds the combinations represent. Finally, one has to also memorize the list of exceptions to the ways in which sounds and spellings correspond. Again, these are formidable obstacles to obtaining literacy.

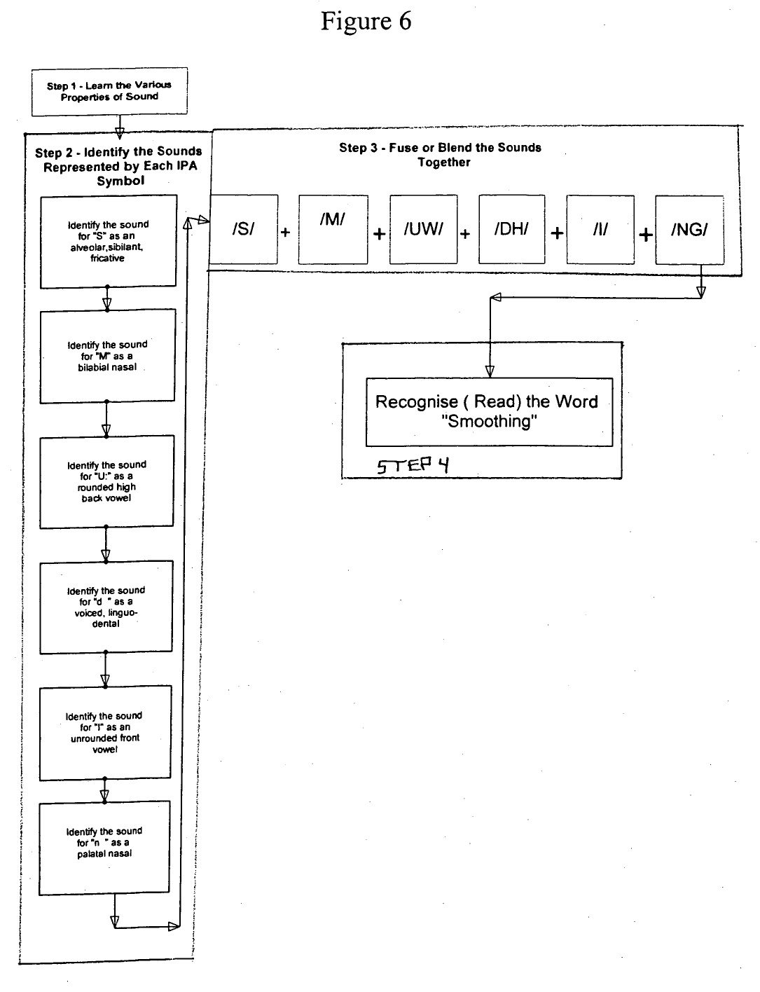

C. The Process of Reading and Writing in the International Phonetic Alphabet (See FIGS. 6 and 6)

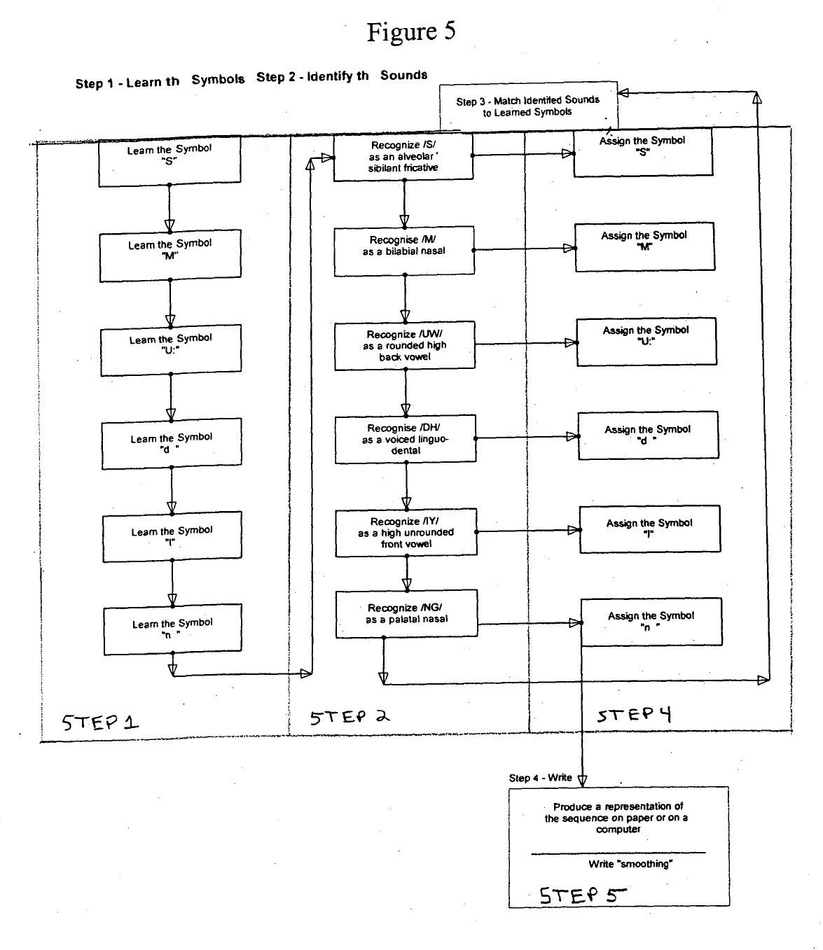

In some cases, such as codes, each pattern may represent an entire sentence. In the case of Chinese writing, each pattern may represent a single idea, like a word. In the case of certain portions of Japanese writing, each pattern may represent a whole syllable. In the case of the international phonetic alphabet (IPA) used by linguists, each pattern may represent a distinct sound. The most logical and precise of the above-mentioned codes is the IPA. The IPA is exemplified by the following steps which are shown in FIGS. 5 and 6.

As seen in FIG. 5, writing using the IPA requires the following steps:

Step 1

Learn the symbol “S”.

Learn the symbol “M”.

Learn the symbol “U:”.

Learn the symbol “δ”.

Learn the symbol “I”.

Learn the symbol “η”.

Step 2

Recognize the first sound is an alveolar sibilant fricative for which the corresponding IPA symbol is “S”. Recognize the next sound is a bilabial nasal for which the corresponding IPA symbol is “M”. Recognize the “oo” sound as a rounded high back vowel for which the corresponding IPA symbol is “U:”. Recognize “th” as a voiced linguo-dental fricative for which the corresponding IPA symbol is “δ”. Recognize the “iy” sound as a high unrounded front vowel for which the corresponding IPA symbol is “I”. Recognize the “ng” sound as a palatal nasal for which the corresponding IPA symbol is “η”.

Step 3

Match the identified sounds to the learned symbols.

Step 4

Assign the corresponding IPA symbol is “S”. Assign the corresponding IPA symbol is “M”. Assign the corresponding IPA symbol is “U:”. Recognize “th” as a voiced linguo-dental fricative for which the corresponding IPA symbol is “δ”. Assign the corresponding IPA symbol is “I”. Assign the corresponding IPA symbol is “η”.

Step 5

Produce a representation of this sequence with a presentation device such as ink on paper or a computer driven display.

As seen in FIG. 6, Reading Using the IPA requires the following steps:

Step 1

Learn the various properties of sound such an alveolar sibilant fricative as in the beginning sound of the word “soup”, a bilabial nasal as in the beginning sound of the word “mouse”, a rounded high back vowel as in the vowel sound in the word “boo”, a voiced linguo-dental fricative as in the beginning sound in the word “that”, a high unrounded front vowel as in the vowel sound in the word “ink”, and a palatal nasal as in the ending sound in the word “ring”.

Step 2

Identify the sounds represented by each IPA symbol. Identify the sound for the symbol “S” as an alveolar sibilant fricative as in the beginning sound of the word “soup”. Identify the sound for the symbol “M” as a bilabial nasal as in the beginning sound of the word “mouse”. Identify the sound for the symbol “U:” as a rounded high back vowel as in the vowel sound in the word “boo”. Identify the sound for the symbol “δ” as a voiced linguo-dental fricative as in the beginning sound in the word “that”. Identify the sound for the symbol “I” as a high unrounded front vowel as in the vowel sound in the word “ink”. Identify the sound for the symbol “η” as a palatal nasal as in the ending sound in the word “ring”.

Step 3

Fuse or blend the learned sounds.

Step 4

Recognize the word from those blended sounds as “smoothing”.

Thus, to understand how to use the IPA, one must first study the various properties of sound. These are classified in this system by many different methods including whether they are voiced or unvoiced, stopped or more continuous, what the position of the lips and tongue are and other various properties. Once one understands sound to prepare to use the IPA in a language, one first identifies the phonemes for that language. One may then identify, for each phoneme, all of its allophones or variants, as well as the patterns where a given allophone is used. For each of these allophones, one then finds the IPA symbol for that sound, making a final decision as to which of those memorized symbols is most appropriate for the sound, and one memorizes or learns the corresponding IPA symbol.

To write any word, one first analyzes the word into its constituent sounds, usually one syllable at a time. One writes in sequence the IPA symbol chosen or assigned for that sound. To read any word, one takes the first symbol and makes the corresponding sound, and repeats that process for each symbol in the word. One then fuses together those sounds and recognizes the word from that fusion of sounds. If the dialect the word was written in is different from one's own dialect, the fusion will sound more like the writer's dialect than the reader's and the reader will perform the additional step of recognizing the word in their own dialect that matches the word as pronounced in the writer's dialect.

In some ways IPA is the easiest code to learn because, for use with any given language, one only has to learn a few dozen characters. Therefore, its advantage over Chinese writing is enormous because Chinese writing requires tens of thousands of characters. Moreover, the IPA's representation of sound for any given language is unambiguous. Therefore, there is no need for learning complicated spelling rules within the framework of the IPA. Even Spanish, which may have one of the more consistent writing systems in existence, requires one to learn, for example, that a “g” followed by a “u” is pronounced completely different from a “g” followed by an “i”. Moreover, a “u” after a “g” is not pronounced at all if followed by an “e” or an “i” in Spanish, unless of course there is a pair of dots placed over it.

The IPA's regularity dispenses with any need for “spelling rules”. Accordingly, the IPA possesses much regularity. On may simply read by a process of chaining together the sounds which each symbol represents, and write by a process of splitting a word one wants to express into sounds; thereby generating a list of symbols that correspond to the appropriate sound. In spite of those advantages, there are good reasons why this system is not widely used outside of the academic language study world.

First, while the use of the symbols within the IPA is logical and consistent, the symbols themselves are not. Each symbol of the IPA is a pure symbol whose sound meaning must be learned by rote memorization, e.g. a rote symbol. Rote memorization of pure symbols involves substantial effort for which the repayment is that there is virtually nothing you can read in that writing system. More specifically, no one language uses any of the IPA pure symbol set as the basis of its means of communication. Most people find that the effort which would have to be expended in rote learning of the IPA pure symbol set is better used to master a form of writing that is being used by everything and everyone they actually want to read.

There is an additional more subtle problem with the IPA. On the one hand, it can convey pronunciation with a fairly high degree of precision. On the other hand, it must. And so regional dialect distinctions must be represented in the writing, which can in itself be a barrier to communication. Therefore, the IPA can not fail to represent dialect distinctions. For example, the word “pen” as pronounced by a native of Kansas sounds different from the same word pronounced by a native of Alabama. The IPA representations for these two pronunciations will necessarily be different. Moreover, in many languages, including German and Portuguese, there is a predictable variation in some sounds at the end of a word, depending on the dialect.

In addition, the IPA imposes an unnecessary burden on the native speaker of a language, in that there are sound distinctions which the IPA makes which are irrelevant to the native speaker. For example, in the four English words “style”, “tile”, “bat”, and “batter”, there are four distinct sounds represented by “t” which a native English speaker always pronounces distinctly, yet never bothers to cognitively distinguish one pronunciation from the others. An initial “t”, as in “tile”, is always pronounced as an unvoiced plosive alveolar stop, while a “t” after the sibilant “s” is always pronounced as an unvoiced alveolar stop. If the native language is English for example, one can easily tell the two apart by holding one's palm in front of one's mouth and noticing the strong puff of air one feels when saying “tile”. This puff of air is absent when one says “style”. Most native English speakers, however, are completely unaware of the fact that they say those two sounds differently because this difference in sound is never used in English to distinguish between two words. If one replaces the pronunciation of the “t” sound in “tile” with the “t” sound in “style”, one will be understood though may also seem to have a slight Latin accent. French and Spanish do not make the above distinction at all. In linguistic terms, all of the above-mentioned sounds exemplified by “t” are distinct allophones of the same phoneme. Since native speakers of languages are usually not even conscious of such fine linguistic points, it is an unnecessary burden on them to force them to become aware of such fine linguistic points in order to read and write.

The unicode standard is an attempt to codify all the existing writing systems in the world, assigning a number to each character so as to be able to unambiguously interchange via computer networks expressions in any such system. While it omits some dead languages, and some languages with so few computer literate people that no standard computer form of the language exists, it is probably the most exhaustive collection of characters in existence.

The unicode standard is a list consisting of the alphabet, the Greek alphabet, the Cyrillic alphabet, the Chinese characters, the Korean characters, the Hindi alphabet, the Hebrew alphabet, the Arabic alphabet, and so on. Each character in the list has been assigned a number, in the same way that the ASCII code assigns a number to each letter of the alphabet. This enables computers to interchange documents written in practically any language, without any ambiguity. Reading and writing using unicode is not different from reading and writing using the alphabet, or the Greek alphabet, or Chinese characters, or whatever. It is just a way for computers to agree on which characters are which. For Example, when you type a letter “a”, the computer does not have a little picture of an “a” running around its circuits, the “a” gets stored internally as a number, the same way it stores the number 97. “b” gets stored as 98, and so on. It's only when the letter needs to be displayed that the number 97 gets converted to the picture “a”.

There are of course ways of conveying isolated ideas which do not constitute representations of language. One example of such a way may be charades. Charades involves gestures designed to elicit specific words, and the difficulty of conveying the handful of words in a round of the game shows how unsuitable this mechanism is for conveying actual sentences. Likewise, diagrams and pictures, while often useful for understanding some utterance, don't in and of themselves constitute writing. But in this sense, writing may not only include scratching Chinese characters in the sand, or typing Arabic characters into a computer, but may also include sending naval semaphore signals, or tapping Morse code, or signing for a deaf person.

Pictorial writing systems may also provide literacy. Probably all writing systems originated as pictures. The advantage of using pictures is that they are mnemonic which is unlike the alphabet which requires years of training to be used effectively. Pictures are recognizable, and hence memorable. In fact, nearly all of the characters used in the worlds writing systems, as they have been gathered together into the unicode standard, are historically derived from pictures. The disadvantages of those original systems are quite high. Pictures are expensive and time consuming to produce, and not everyone has the level of artistic ability it takes to produce readily recognizable pictures. In fact, all of the characters which originated thousands of years ago as pictures but which have been extensively modified over time appearing in the unicode standard have long since lost any pictorial meaning they once had. If one was told what picture each character of the unicode standard historically developed from, one might be able to envision the faint traces, but one would be unlikely to look at any of the characters of the unicode standard and recognize such traces without such information being provided to them. For example, one would not be able to say “oh, that's a picture of a mountain” without being told that the Chinese character appearing in the unicode standard once derived from a picture of a mountain. For example, the letter “s” once was a picture of a “snake”. If one had this knowledge, one could look at an “s” and see how that could be a “snake”, but when one sees an “s”, one's first thought probably is not “snake”.

In other words, while all writing started out as pictures, no language was ever both fully pictographic and fully alphabetic. In fact, the pictures used in writing have become less pictorial over time to the point where today one cannot look at any of the characters used in any written language today and recognize any of them as pictures. In some cases, if told what the original picture was, one may look at it and see the faint echoes of the picture that once was. When analyzing the Egyptian hieroglyphics, which are the most clearly pictorial writings known, several of the pictures do not in fact depict what one may be convinced that they must have been depicting.

One reason for the downfalls of pictorial languages is, in part, that without the additional elements of computers, and typesetting and image manipulation software, and image production techniques like monitors and printers, this style of writing is not practical. The cost of making the same pictures over and over again, to a standard that can be recognized without extensive tutelage, is just too high. Another reason for these downfalls is, in part, that without the additional element of using multiple images to convey sound that are never, or only rarely word initial, a fully alphabetic pictographic writing system cannot be completed in most languages, and quite possibly in no language at all. So there have been writing systems that were largely, but perhaps never fully, pictographic. Also, there have been writing systems that were largely, but only in the case of the IPA and perhaps Finnish, fully alphabetic (ie phonetic). However, never have both elements been combined.

Egyptian writing uses stylized shapes for its symbols. Some, but not all, of these symbols are readily recognizable today. Other symbols are recognized to convey an unintended understanding. For example, one symbol is clearly a snake. For example, one symbol clearly looks like a “feather”, however, it is not a “feather” at all, but instead is a “reed”. Other symbols are not readily recognizable, but are believable when pointed out such as the picture for a “courtyard”. Such symbols are not recognizable symbols but instead are remembered symbols. Still further, some symbols such as “placenta”, is not especially recognizable or even easily recognized when pointed out. Such symbols must be incorporated by rote memorization and are therefore rote symbols. Each of the words associated with these rote symbols had the property of starting with the sound that symbol represented. For example, the symbol the Egyptian writing uses which is the precursor to the roman character “s”, is a picture of a snake. While the Egyptian word for “snake” was of course not “snake”, it was a word which also happens to start with the same sibilant sound, since snakes hissssss, lots of languages have a hissing sound in their word for snake. Accordingly, no writing system has succeeded in being truly pictorial though, of course, pictures and incomplete pictographic elements and methods are still used for teaching children, such as “a is for apple,” “a is for acorn,” “a is for armadillo,” etc.

In light of the above, it is understood that the readily recognizable pictures would have required no learning (i.e. recognizable symbols), while the believable pictures would have required some minimal learning (i.e. remembered symbols). Finally, pictures not recognizable, and therefore not readily remembered, require some rote memorization (i.e. rote symbols). For the reader, the greatest disadvantages of this Egyptian writing system are that there are no symbols for vowel sounds because no suitable pictures are found and some of the symbols simply must be learned by rote memorization (i.e. rote symbols), rather than simply recognized or remembered (i.e. recognizable symbols or remembered symbols, respectively).

Meanwhile, there are substantial difficulties for the writer. More specifically, the writing requires substantial time and effort to draw each picture over and over again. For all of these reasons, this system of Egyptian writing still requires a substantial investment in rote memorization and a substantial amount of time to be able to utilize the same effectively to communicate. Accordingly, it is replaced by the sort of alphabetic writing which uses the easily written, but not pictorial characters, of the sort one presently may be reading within this document.

Thus, the present inventors have recognized that combating illiteracy by teaching existing reading and writing systems have failed due to the substantial investment required to learn existing systems. The present inventor has arduously pursued the creation of a communication means by which writing and reading can be achieved without the above problems described in current and past communication means. To be able to read and write using the present invention, no knowledge of any alphabet or characters is required; nor is the ability to draw or move a pen required of either the reader or the writer. No symbols need to be memorized, no stylized symbols need be remembered. All that is required is the cognitive ability to make sense of sounds, the sensory ability to identify objects by sight or by touch, and a knowledge of the word in the language which is being represented.

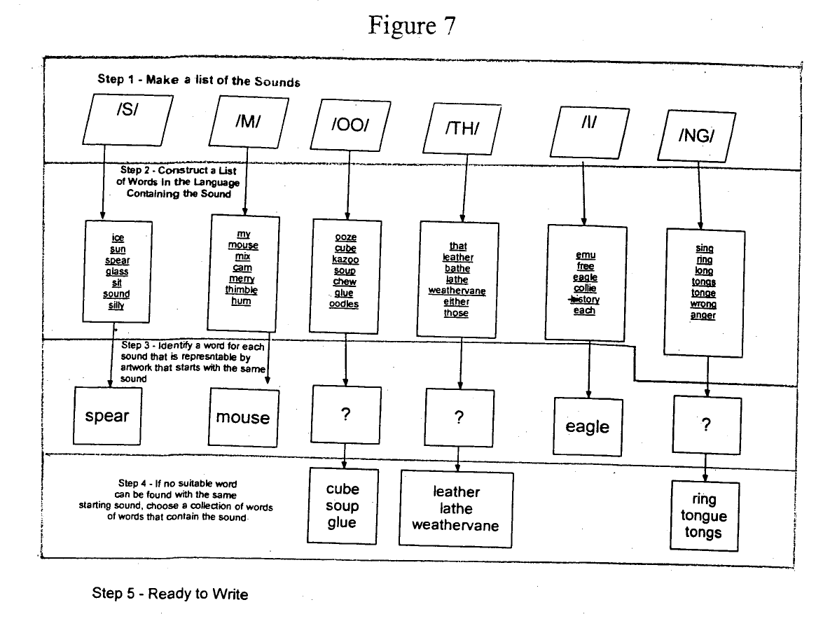

FIG. 7 is a process diagram illustrating a process to prepare for writing in accordance with an embodiment of the present invention. The process includes the following steps:

Step 1

One makes a list of all of the sounds within the language one is working for the word “smoothing.

Step 2

One constructs a list of words in the language containing that sound.

Step 3

One identifies a word or words for each sound that is clearly able to be represented by an object or a piece of artwork that starts with that sound.

Step 4

If there is no such word, one chooses a collection of words that contain the sound and that can be clearly represented by an object or artwork. One wants the collection to be small, but large enough that the sound the collection has in common can be clearly identified. One may gather objects, create sculptures and/or generates artwork for these choices. To write, one may assemble the objects or representations of them. If one is using artwork, one may compose those pieces of artwork in the same way as typesetting composites characters from a font.

Step 5

Ready to write.

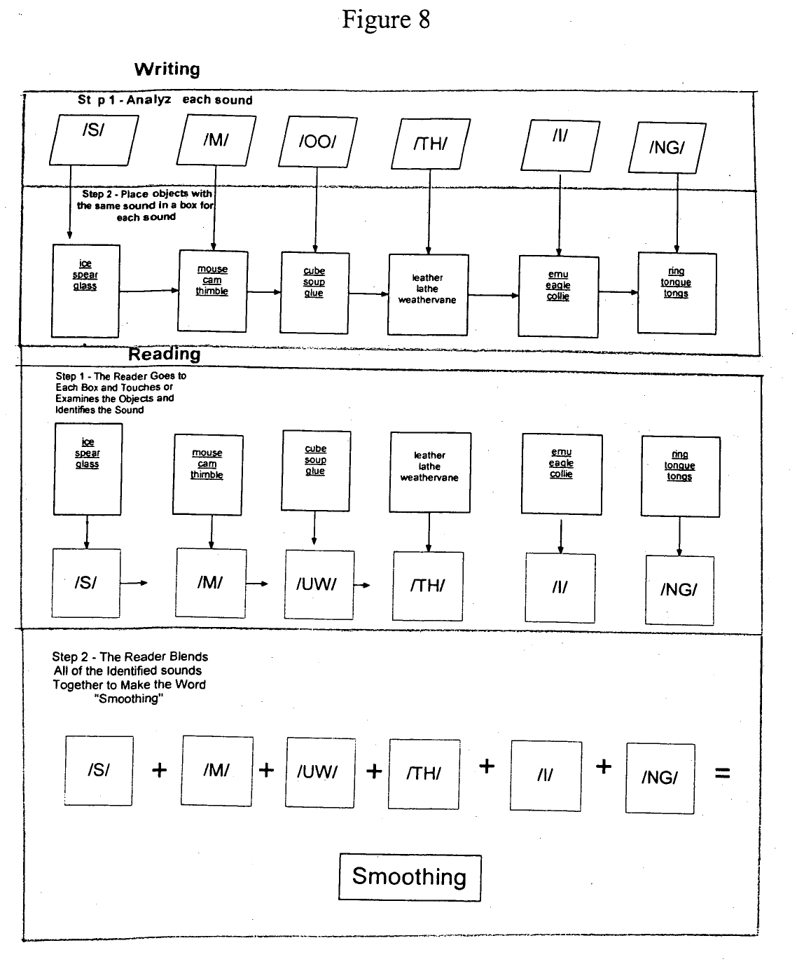

FIG. 8 illustrates a process for writing and reading, in accordance with the present invention.

The embodiment of FIG. 8 is not very efficient for writing, but has the advantage of requiring only minimal intelligence and no learning on the part of the reader. To write a word, one first analyzes each word into syllables and then identifies all of the sounds in each syllable. For each sound, one gets a box and places all of the boxes in a row. For each sound, one thinks of objects that contain that sound and places them in the boxes in the same order as the sound sequence in the word with an arrow which points from the beginning of the row to the end. To more clearly illustrate the process of both reading and writing using the method and the steps involved in the present invention, one will use as an example the English word “smoothing”.

Step 1

Identify the first sound in “smoothing” as an /S/ sound and think of things that contain that sound. Identify the second sound as an /M/ sound and think of things that contain that sound. Identify the next sound as an /UW/ sound and think of things that contain that sound. Identify the next sound as a /DH/ sound and think of things that contain that sound. Identify the next sound as an /IY/ sound and think of things that contain that sound. Identify the final sound as an /NG/ sound and think of things that contain that sound.

Step 2

Place in the first box some ice, a spear and a glass for the /S/ sound.

Place in the second box a mouse, a cam and a thimble for the /M/ sound. I Place in the third box a cube, some glue and some soup for the /UW/ sound. Place in the next box a lathe, some leather and a weathervane for the /DH/ sound. Place in the next box a collie, an eagle and an emu for the /IY/ sound. In the last box, place a ring, a tongue and some tongs for the /NG/ sound.

As seen in FIG. 8, to read what has been written, the reader goes to the first box marked by the arrow and either looks in the box or reaches in to touch the things in the box. The reader then identifies the sound that is common to all of the objects. The reader then moves down the row from box to box retrieving the sounds. Once the reader has determined all of the sounds, the reader strings them together to figure out the word. In practice, the reader may perform this method one syllable at a time because it may be more effective use of the reader's short term memory. Again, to more clearly illustrate the process of both reading and writing using this method and the steps involved, one will use as an example the English word “smoothing”.

Step 1

The reader goes to the first box and examines or touches the ice, the spear and the glass and identifies the first sound as an /S/ sound. The reader goes to the second box and examines or touches the mouse, the cam and the thimble and identifies the second sound as an /M/ sound. The reader goes to the next box and examines or touches the cube, the glue and the soup and identifies the third sound as a /UW/ sound. The reader moves to the next box and examines or touches the lathe, the leather and the weathervane and identifies the fourth sound as a /DH/ sound. The reader goes to the next box and examines or touches the collie, the eagle and the emu and identifies the fifth sound as the /IY/ sound. The reader goes to the final box and examines or touches the ring, the tongue and the tongs and identifies the final sound as the /NG/ sound.

Step 2

The reader then blends together the sounds /S/+/M/+/UW/+/DH/+/I/+/NG/ to produce the word “smoothing”. If the reader speaks a different dialect from the writer, the sound he associates with those pictures may not be identical to the sound that the writer was thinking. However, because of the regularity with which dialectic differences often occur, this shifting of sounds can occur automatically, without either writer or reader being aware of it. If the writer from parts of the south was thinking “hiyin” or “piyin”, those pictures will read as “hen” and “pen” to the reader from parts of the mid-west. This same mechanism works identically in many languages, including German and Portuguese. As long as you choose pictures which make as many distinctions as the other dialects make, the reader will be able to read your writing and have it sound to him largely as though it had been written in his own dialect. Thus, for example, if you are writing in German, and speak a dialect that does not pronounce “g” differently at the end of a word, if you still choose your representations from words that end in the “g” sound, those words will convey to a speaker of a dialect that does pronounce “g” differently at the end of a word, that different sound, automatically.

In another embodiment of the invention representation of objects may be used rather than the objects themselves. Of course, it would be more practical to use representations such as drawings or sculptures of the objects in the boxes rather than the actual objects. Since there is a relatively small number of sounds in any given language, it is best to mass produce the drawings or sculptures. The drawings may be standardized and replicated on individual media such as stamps or ink stamps. Then, instead of choosing any object one likes, one just chooses from the objects for which that one has stamps. This approach may work equally well using drawn boxes on a computer screen with 2d or 3d graphic representations of the objects. Both reading and writing would proceed as outlined in the examples and steps for Level 1.

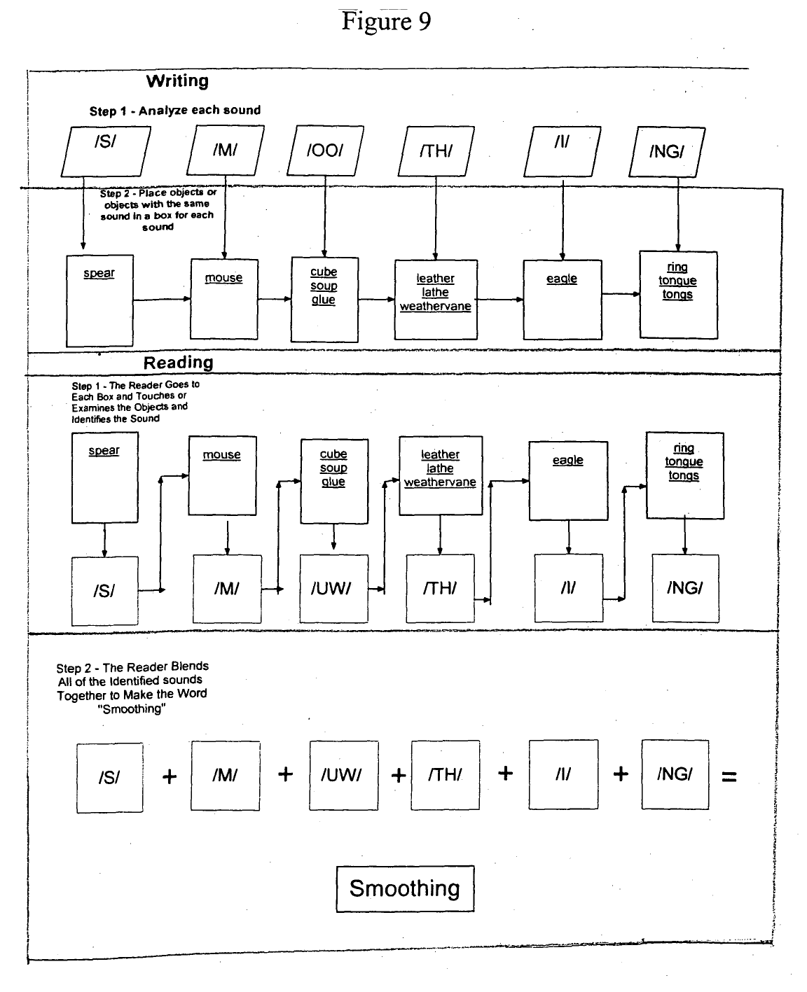

In yet another embodiment, one may use only one object in each box if that object starts with the sound one required. If one can't find a suitable object that starts with the sound one requires, one may still use multiple objects to extract the common sound. To illustrate this, again, one may use the word “smoothing”. FIG. 9 illustrates a process for writing and reading in accordance with this embodiment of the present invention. As seen in this figure, the steps are very similar to that of writing according to Level 1 described above except for the following indicated changes.

Step 1

Identify the first sound in “smoothing” as an /S/ sound and think of things that contain that sound. Identify the second sound as an /M/ sound and think of things that contain that sound. Identify the next sound as an /UW/ sound and think of things that contain that sound. Identify the next sound as a /DH/ sound and think of things that contain that sound. Identify the next sound as an /IY/ sound and think of things that contain that sound. Identify the final sound as an /NG/ sound and think of things that contain that sound.

Step 2

Instead of putting a spear, some ice and a glass in the first box, one only places a spear or a representation of one in the box corresponding the /S/ sound. Instead of putting a mouse, a cam and a thimble in the box, one only places a mouse or a representation of one in the box corresponding for the /M/ sound. In the next box, one continues to use the cube, the glue and the soup (or representations of them) because one may not be able find a suitable object that starts with the /UW/ sound. In the next box, one also continues to use the leather, the lathe and the weathervane (or representations of them) because the only words in English that start with the /DH/ sound are words like “the”, “this”, “that”, “then”, “there” and “though” which aren't objects; and therefore, cannot be put in a box or depicted. In the next box instead of the collie, the emu and the eagle, one only places the eagle or a representation of one in the box to correspond with the /I/ sound. In the last box, one again continues to use the ring, the tongue and the tongs (or representations of them) because one may not be able to find an object that begins with the /NG/ sound.

As seen in FIG. 9, reading according to this embodiment requires the following steps.

Step 1

The reader observes or feels that there is just one object in the first box, e.g. the spear. The reader observes or feels that there is just one object in the second box, e.g. the mouse. The reader observes or feels that there are three objects in the third box, e.g. the cube, the glue and the soup, as before in Level 1. The reader observes or feels that there are three objects in the fourth box, e.g. the lathe, the leather and the weathervane as before in Level 1. The reader observes or feels that there is just one object in the fifth box, e.g. the eagle. The reader observes or feels that there are three objects in the last box, e.g. the ring, the tongue, and the tongs as before in Level 1.

The reader identifies the first sound as /S/, the first sound in the word “spear”. The reader identifies the second sound as /M/, the first sound in the word “mouse”. The reader identifies the common sound as the /UW/ sound. The reader identifies the common sound as the /DH/ sound. The reader identifies the fifth sound as /IY/, the first sound in the word “eagle”. The reader identifies the common sound as the /NG/ sound.

Step 2

The reader then blends together the sounds /S/+/M/+/UW/+/DH/+/I/+/NG/ to produce the word “smoothing”.

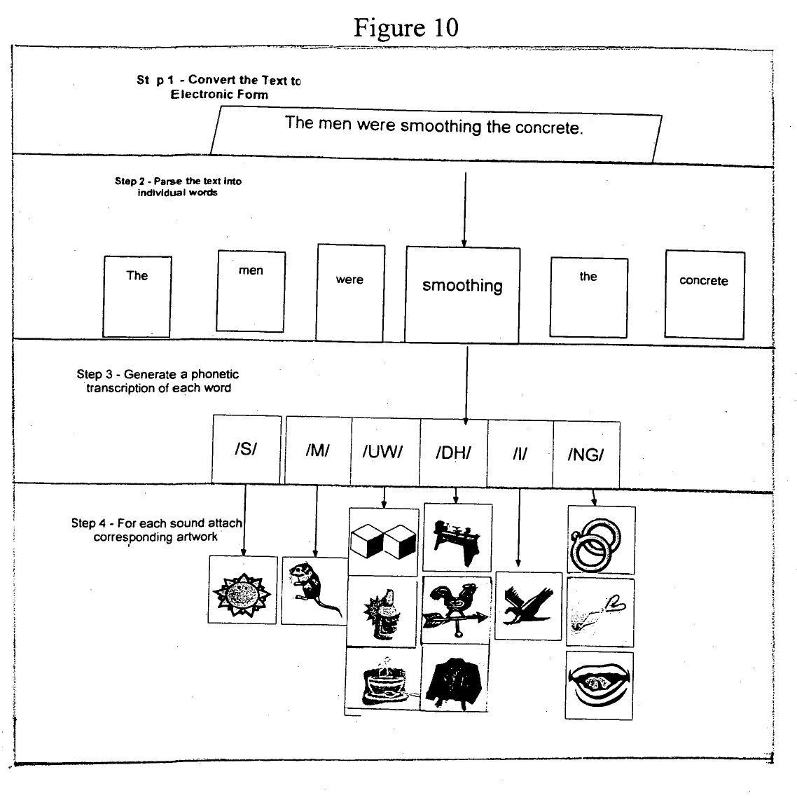

In one embodiment, the present invention may be applied to a system or method for converting an existing standard of writing to the inventive method of writing. The steps for this method are shown in FIG. 10, as follows:

Step 1

If the text is not already in an electronic form, one may convert it. The preferable electronic form may be Unicode.

Step 2

Next, one may parse the text into individual words.

Step 3

For each word, one may generate a phonetic transcription of the word.

In the case of some languages, such as Finnish, the phonetic transcription may be directly produced from the standard writing system. For other languages, such as Chinese, a phonetic dictionary (Such phonetic dictionaries can be found online) may be used. For most languages, such as Greek, an intermediate situation occurs where much of the phonetic expression may be generated algorithmically, but there is a large table of exceptions. Of course the occasional homograph may require human intervention. Phonetic dictionaries are generally available, and where they do not provide division into syllables, the rules identified by linguists may be used. The simple device of identifying the consonant clusters that occur at the beginning and at the end of words gives an indication that syllables are likely to end the same way words do, and begin the same way words do, and often that insight is enough to automate the process of dividing words into syllables.

Step 4

For each sound occurring in the phonetic transcription, one attaches the corresponding artwork.

To convert text represented in this form to a standard representation, one simply reverses the steps by converting first into a phonetic transcription by using the table that one used to convert sounds into artwork (e.g. performing the conversion in the opposite direction). Next, one uses the phonetic dictionary to convert to the classical written form. Further, to communicate with illiterate people, one may combine a representation the above-mentioned form with a presentation device such as ink on paper or a computer driven display.

By writing, using the present invention, one can express oneself, figure things out, entertain oneself and others, create beautiful calligraphies, raise difficult subjects from a distance, persuade others over time and distance such things as to buy, or sell, or donate or volunteer, to provide a job or to accept one, to support or oppose a cause, to love. One can tell people about events like weddings, parties, births, graduations. One can train people over time and distance, or inform them about products and their features, how to use products and their features, how to be safe with products and their features. One can identify oneself with badges and business cards and calling cards. One can label things with signs.

By writing using the present invention, one can disseminate news, events, information, teaching, and warnings. One can entertain with books and magazines, comic books and games. One can create word games, using patterns in words, or fortunes or horoscopes. One can create letters, and agreements, make notes, create calendars, draw up legal documents like wills. One can inform with textbooks, dictionaries, encyclopedias, atlases, journals, newspapers and news websites. One can provide instructions for following recipes and patterns and maps and directions for following medical advice or taking medicines. One can provide diagnostic information, and request diagnostic information. One can provide instructions for learning a skill, such as caring for a car, or taking care of one's health, or complying with laws, or pursuing a sport or hobby or profession. One can award certificates, diplomas, plaques, honor rolls, and trophies.

In addition, the present invention allows one to facilitate events with tickets and programs and posters. One can create scripts and show credits and create subtitles and closed captions. One can announce events and list schedules for programs, showings, and broadcasts. One can express oneself or give self expression to others, such as with sayings on t-shirts and bumper stickers and decals. One can create signs to give directions or provide warnings.

One can conduct surveys, create proposals, recruit and provide job descriptions, job instruction and training, and create and fill out job applications. One can create products with sophisticated interfaces, providing control and feedback. One can provide quotes, order forms, release forms. One can advertise via mail, or postcards, pamphlets, brochures, flyers, postage paid reply cards, circulars, leaflets, catalogs, posters, billboards, signs, websites, menus, or through a vending machine, or one can advertise via merchandising materials like coffee mugs, t-shirts, pens, clocks, dartboards, bumper stickers, decals and key chains. One can create packaging that informs and sells, manuals, and ingredient list labeling. One can provide coupons and gift certificates and tickets. One can create warning labels and safety information sheets. One can generate invoices, purchase orders, order forms, bills of lading, pick lists, receipts, bills and contracts. One can make policy manuals, memos, resumes and forms.

One can create a prospectus, certificates for stocks and bonds and derivatives and letters of credit, deposits, mortgages and insurance policies, as well as the claim forms, application forms and agreements. One can generate checks, credit cards, passbooks, statements for checking and savings, and credit and brokerage accounts. One can create currency and coin, lottery tickets, betting forms, and trading forms. One can draft orders, summonses, briefs, pleadings, wills, contracts, notices, licenses, affidavits and notaries. One can generate tax and customs forms, declarations, census forms, consent forms, ballots, filings, identification, and prescriptions. One can create letters, greeting cards, telexes, telegrams, faxes, and personal ads. One can also participate in chat rooms and email. One can persuade, sermonize, proselyte, teach, train, indoctrinate, buy, sell, negotiate, and instruct.

Even just as important, one can do all of the above electronically using the present invention. One can create interfaces for machines, computers, with graphic components like menus and buttons to select, and text boxes. One can provide means for naming files and grasping file structures, provide informative messages and error messages, elicit security information like passwords and pass phrases. One can create software that uses writing to interact with the software user so they can back up and restore, perform artistic tasks like create and edit raster or vector graphics, animations, video, audio, or combinations, like desktop publishing, web page development, creation of greeting cards, scrap books, albums and labels, and typesetting, and printing. Then, one can undergo pattern creation, or Plano gram layout, architectural or mechanical design, interior decorating, and landscaping.

Further, one can undergo word processing such as text editing or presentations or email; educational software, such as for language learning or translation, spell and grammar checkers, reference libraries, and skill development like typing, or math; financial tasks such as spreadsheets and checkbooks and tax planning and reporting and accounting, auctions, in all their forms, account access to bank accounts, brokerage accounts, mortgage accounts, credit accounts, investment tools and indicators, billing and sales management and customer tracking and invoicing and reporting and shipping; catalogs, directories, database access and update, search engines; communications applications like chat and email and paging and web browsing, and voice over IP and video conferencing and fax over IP and filtering content and fire walling and remote access such as telnet and ftp and ssh and rpc and web services and bulletin boards such as user net and news groups and news services and event notifications such as TV guides, and making connections, like personal ads and reuniting old affiliations like school and church and work and club and neighborhood or other organizations, and natural parents and children separated from them, and genealogy, and web gateways to all of those; control of peripherals such as telephones and scanners and fax modems and cameras and X10 devices and industrial equipment, and providing interfaces for kiosks, touchscreens, video catalogs, point of purchase systems, barcode reader, automated teller machines, automobiles, airplanes, and other vehicles and machines; games; organizational tools like calendars, planners, contact mgmt, sales tracking, maps, directions, birthday reminders, task reminders, Visio, Plano gram, flow charts, organizational charts, project mgmt, forms such as wills, contracts, business plans; conversion of speech to text, text to speech, physical text to electronic text, electronic text to physical text; provide means for one click checkout, or for hyper linking to other sources of information.

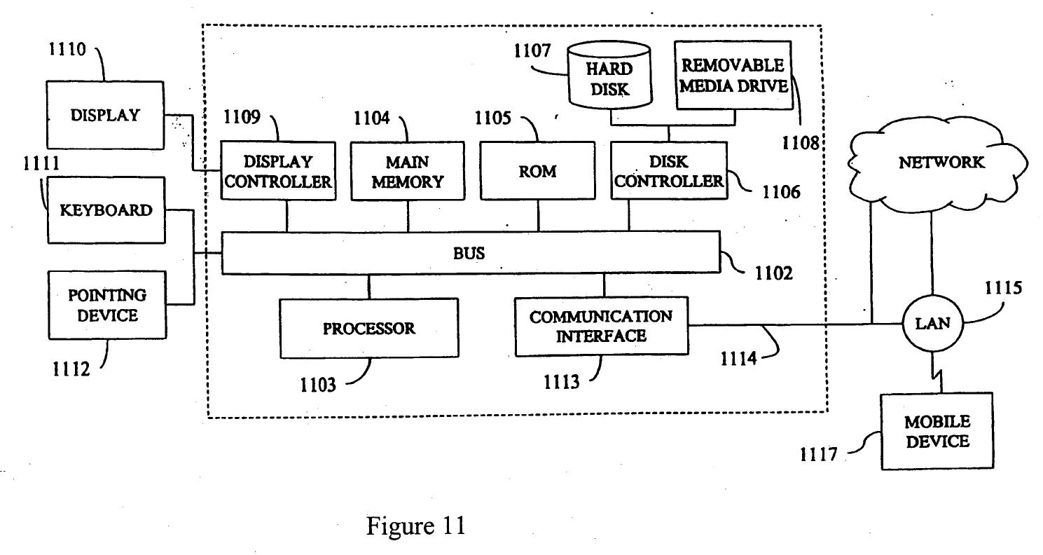

One of the embodiments of the present invention includes an apparatus capable of providing the method according to the present invention. A more specific embodiment is that the apparatus may be, for example, a computer system, among the others mentioned above. FIG. 11 illustrates a computer system 1101 upon which an embodiment of the present invention (entirely or partially) may be implemented. The computer system 1101 includes a bus 1102 or other communication mechanism for communicating information, and a processor 1103 coupled with the bus 1102 for processing the information. The computer system 1101 also includes a main memory 1104, such as a random access memory (RAM) or other dynamic storage device (e.g., dynamic RAM (DRAM), static RAM (SRAM), and synchronous DRAM (SDRAM)), coupled to the bus 1102 for storing information and instructions to be executed by processor 1103. In addition, the main memory 1104 may be used for storing temporary variables or other intermediate information during the execution of instructions by the processor 1103. The computer system 1101 further includes a read only memory (ROM) 1105 or other static storage device (e.g., programmable ROM (PROM), erasable PROM (EPROM), and electrically erasable PROM (EEPROM)) coupled to the bus 1102 for storing static information and instructions for the processor 1103.

The computer system 1101 also includes a disk controller 1106 coupled to the bus 1102 to control one or more storage devices for storing information and instructions, such as a magnetic hard disk 1107, and a removable media drive 1108 (e.g., floppy disk drive, read-only compact disc drive, read/write compact disc drive, compact disc jukebox, tape drive, and removable magneto-optical drive). The storage devices may be added to the computer system 1101 using an appropriate device interface (e.g., small computer system interface (SCSI), integrated device electronics (IDE), enhanced-IDE (E-IDE), direct memory access (DMA), or ultra-DMA). Or serial ATA, or firewire, or USB or fibre channel.

The computer system 1101 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1101 may also include a display controller 1109 coupled to the bus 1102 to control a display 1110, such as a cathode ray tube (CRT), for displaying information to a computer user. The computer system includes input devices, such as a keyboard 1111 and a pointing device 1112, for interacting with a computer user and providing information to the processor 1103. The pointing device 1112, for example, may be a mouse, a trackball, or a pointing stick for communicating direction information and command selections to the processor 1103 and for controlling cursor movement on the display 1110. In addition, a printer may provide printed listings of data stored and/or generated by the computer system 1101.

The computer system 1101 performs a portion or all of the processing steps of the invention in response to the processor 1103 executing one or more sequences of one or more instructions contained in a memory, such as the main memory 1104. Such instructions may be read into the main memory 1104 from another computer readable medium, such as a hard disk 1107 or a removable media drive 1108. One or more processors in a multi-processing arrangement may also be employed to execute the sequences of instructions contained in main memory 1104. In alternative embodiments, hard-wired circuitry may be used in place of or in combination with software instructions. Thus, embodiments are not limited to any specific combination of hardware circuitry and software.

As stated above, the computer system 1101 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1101, for driving a device or devices for implementing the invention, and for enabling the computer system 1101 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1103 for execution. A computer readable medium may take many forms, including but not limited to, non-volatile media, volatile media, and transmission media. Non-volatile media includes, for example, optical, magnetic disks, and magneto-optical disks, such as the hard disk 1107 or the removable media drive 1108. Volatile media includes dynamic memory, such as the main memory 1104. Transmission media includes coaxial cables, copper wire and fiber optics, including the wires that make up the bus 1102. Transmission media also may also take the form of acoustic or light waves, such as those generated during radio wave and infrared data communications.

Various forms of computer readable media may be involved in carrying out one or more sequences of one or more instructions to processor 1103 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1101 may receive the data on the telephone line and use an infrared transmitter to convert the data to an infrared signal. An infrared detector coupled to the bus 1102 can receive the data carried in the infrared signal and place the data on the bus 1102. The bus 1102 carries the data to the main memory 1104, from which the processor 1103 retrieves and executes the instructions. The instructions received by the main memory 1104 may optionally be stored on storage device 1107 or 1108 either before or after execution by processor 1103.

The computer system 1101 also includes a communication interface 1113 coupled to the bus 1102. The communication interface 1113 provides a two-way data communication coupling to a network link 1114 that is connected to, for example, a local area network (LAN) 1115, or to another communications network 1116 such as the Internet. For example, the communication interface 1113 may be a network interface card to attach to any packet switched LAN. As another example, the communication interface 1113 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1113 sends and receives electrical, electromagnetic or optical signals that carry digital data streams representing various types of information.

The network link 1114 typically provides data communication through one or more networks to other data devices. For example, the network link 1114 may provide a connection to a another computer through a local network 1115 (e.g., a LAN) or through equipment operated by a service provider, which provides communication services through a communications network 1116. In preferred embodiments, the local network 1114 and the communications network 1116 preferably use electrical, electromagnetic, or optical signals that carry digital data streams. The signals through the various networks and the signals on the network link 1114 and through the communication interface 1113, which carry the digital data to and from the computer system 1101, are exemplary forms of carrier waves transporting the information. The computer system 1101 can transmit and receive data, including program code, through the network(s) 1115 and 1116, the network link 1114 and the communication interface 1113. Moreover, the network link 1114 may provide a connection through a LAN 1115 to a mobile device 1117 such as a personal digital assistant (PDA) laptop computer, or cellular telephone. The LAN communications network 1115 and the communications network 1116 both use electrical, electromagnetic or optical signals that carry digital data streams. The signals through the various networks and the signals on the network link 1114 and through the communication interface 1113, which carry the digital data to and from the system 1101, are exemplary forms of carrier waves transporting the information. The processor system 1101 can transmit notifications and receive data, including program code, through the network(s), the network link 1114 and the communication interface 1113.

Numerous modifications and variations on the present invention are possible in light of the above teachings. It is, therefore, to be understood that within the scope of the accompanying claims, the invention may be practiced otherwise than as specifically described herein. Moreover, English is used as the language to demonstrate exemplified embodiments. It should be understood that the present invention may by utilized for communication within all languages. For example, the following table provides examples of languages in which the present application may be applied.

| Language | Population | Language Family | Region |
|---|---|---|---|
| MANDARIN | 952,000,000 | Sino-Tibetan | CHINA |
| CHINESE | | | |
| English | 470,000,000 | Indo-European | Europe/America/ |
| | | | etc. |
| HINDI | 418,000,000 | Indo-European | INDIA |
| Spanish | 381,000,000 | Indo-European | Europe/America |
| Russian | 288,000,000 | Indo-European | Europe/Central |
| | | | Asia |
| Arabic | 219,000,000 | Afro-Asiatic | Middle East/ |
| | | | N Africa |
| BENGALI | 196,000,000 | Indo-European | INDIA |
| Portuguese | 182,000,000 | Indo-European | Europe/America |
| Malay | 155,000,000 | Malayo-Polynesian | Malaya/Indonesia |
| Japanese | 126,000,000 | Altaic | Japan |
| French | 124,000,000 | Indo-European | Europe |
| German | 121,000,000 | Indo-European | Europe |
| URDU | 100,000,000 | Indo-European | INDIA |
| PUNJABI | 94,000,000 | Indo-European | INDIA |
| Korean | 75,000,000 | Altaic | Korea |
| TELUGU | 73,000,000 | Dravidian | INDIA |
| MARATHI | 70,000,000 | Indo-European | INDIA |
| TAMIL | 69,000,000 | Dravidian | INDIA |
| CANTONESE | 66,000,000 | Sino-Tibetan | CHINA |
| CHINESE | | | |
| SHANGHAI | 65,000,000 | Sino-Tibetan | CHINA |
| CHINESE | | | |
| Javanese | 64,000,000 | Malayo-Polynesian | Indonesia |
| Vietnamese | 64,000,000 | Austroasiatic | Indo-China |
| Italian | 63,000,000 | Indo-European | Europe |
| Turkish | 59,000,000 | Altaic | West & Central |
| | | | Asia |
| Tagalog | 53,000,000 | Malayo-Polynesian | Philippines |
| MIN CHINESE | 50,000,000 | Sino-Tibetan | CHINA |
| Thai & Lao | 50,000,000 | Thai | Indo-China |
| Swahili | 48,000,000 | Niger-Kordofanian | East Africa |
| HUNAN | 48,000,000 | Sino-Tibetan | CHINA |
| CHINESE | | | |
| Ukrainian | 47,000,000 | Indo-European | Europe |
| KANARESE | 44,000,000 | Dravidian | INDIA |
| (Kannada) | | | |
| Polish | 44,000,000 | Indo-European | Europe |
| BIHARI | 42,000,000 | Indo-European | INDIA |
| (Bhojpuri) | | | |
| GUJARATI | 41,000,000 | Indo-European | INDIA |
| Hausa | 38,000,000 | Afro-Asiatic | West Africa |
| MALAYALAM | 35,000,000 | Dravidian | INDIA |
| Persian | 34,000,000 | Indo-European | Iran/Central Asia |
| HAKKA | 34,000,000 | Sino-Tibetan | CHINA |
| CHINESE | | | |
| ORIYA | 32,000,000 | Indo-European | INDIA |
| Burmese | 31,000,000 | Sino-Tibetan | Burma |

These numbers are from The WORLD ALMANAC and BOOK OF FACTS 1995(Funk & Wagnalls, 1994, pp. 598-599); but their table seems to have overlooked Bihari in India and Hunan Chinese, so I have had to use numbers that may now be out of date. General information about world languages may be found in The Languages of the World, by Kenneth Katzner (Routledge & Kegan Paul, revised in 1986). There is a lot of uncertainty about the populations for Chinese “dialects.” These numbers should be compared with the table for Chinese dialects. Thorough treatments of Chinese may be found in The Chinese Language, Fact and Fantasy, by John DeFrancis (University of Hawaii Press, 1984—DeFrancis is one of the major living scholars of Chinese) and The Languages of China, by S. Robert Ramsey (Princeton University Press, 1987).

The population figures for all these languages are for those who speak them as either first or second languages. Several languages are widely used as second languages (especially English, French, Russian, Arabic, Malay, and Swahili), and it is hard to provide numbers for some of them in that capacity. Since Arabic is the language of Islâm, Moslems around the world, as far afield as Indonesia (which is now over 90% Moslem), learn it for religious reasons. By some estimates, up to a billion people could have some competence in English.

The figure for Mandarin includes other Chinese (more than a hundred million) who have learned Mandarin as a second language. Some languages started out as trade languages which were essentially second languages. They continue to have a far smaller number of speakers as first languages than as second. Malay may only be the first language of 50 million people. But as a trade language which has become the national language of Malaysia and Indonesia (called Bahasa Malaysia and Bahasa Indonesia respectively), Malay is one of the major languages of the world. Swahili, which has a large Arabic component (Sawâh.ilî in Arabic means “coastal”), may have fewer than ten million speakers as a first language, and thus would not otherwise have appeared on this list.

1. A method of mutely communicating in a spoken language, comprising:
selecting a word of a language to communicate;
gathering a plurality of recognizable objects each eliciting a sound of the word to be communicated; and
arranging the plurality of recognizable objects such that at least one object corresponds to each sound of the word and the objects are arranged in a sequence that corresponds to a spoken sequence of the sounds of the word.

2. The method of claim 1, wherein said selecting comprises selecting a word from existing text to be mutely communicated using said method.

3. The method of claim 1, wherein said selecting comprises selecting a word from audio speech to be mutely communicated using said method.

4. The method of claim 1, wherein said gathering comprises gathering a plurality of tangible objects each eliciting a sound of said word.

5. The method of claim 4, wherein said gathering comprises gathering a plurality of three dimensional objects each having a shape that elicits a sound of said word.

6. The method of claim 4, wherein said gathering comprises gathering a plurality of objects each having a pictorial representation thereon, which elicits a sound of said word.

7. The method of claim 4, wherein said gathering comprises gathering a plurality of objects each having a tactile feature that elicits a sound of said word.

8. The method of claim 1, wherein said gathering comprises gathering a plurality of non-tangible images each eliciting a sound of said word.

9. The method of claim 8, wherein said gathering comprises gathering a plurality of images displayed on a display screen, each image eliciting a sound of said word.

10. The method of claim 1, wherein said gathering comprises gathering a plurality of objects from a predefined set of objects determined to represent substantially all sounds of the spoken language.

11. The method of claim 1, wherein said gathering comprises gathering a plurality of objects each eliciting a sound of said word according to a predefined set of rules including at least one of the following:
for an isolated object, the first sound of a word of the spoken language associated with said isolated object is the sound elicited by the object, and
for linked objects, the common sound of words of the spoken language associated with each linked object is the sound elicited by the linked objects.

12. The method of claim 1, wherein said arranging comprises physically arranging the objects sequentially in a direction that the spoken language is textually written.

13. The method of claim 1, further comprising determining an obscure sound and a common sound of the word.

14. The method of claim 13, wherein said arranging comprises linking more than one of said recognizable objects to represent said obscure sound, said linked objects having said obscure sound in common.

15. The method of claim 13, wherein said determining an obscure sound comprises determining a sound that cannot be represented by the beginning sound of any recognizable object.

16. The method of claim 13, wherein said determining an obscure sound comprises determining an obscure sound based on a predetermined set of sounds that have been defined as difficult to elicit by use of a recognizable object.

17. The method of claim 1, wherein said selecting a word comprises selecting a plurality of words to communicate a phrase of the language, said method further comprising
gathering a plurality of recognizable objects each eliciting a sound of the phrase to be communicated; and
arranging the plurality of recognizable objects such that at least one object corresponds to each sound of the phrase and the objects are arranged in a sequence that corresponds to the spoken sequence of sounds of the phrase.

18. The method of claim 17, wherein said arranging comprises arranging the plurality of objects in groups corresponding to each word of the phrase.

19. A method of reading a spoken language, comprising:
analyzing an arrangement of recognizable objects organized in sequence;
determining a sound to be elicited by each of said recognizable objects according to a predetermined set of rules;
blending said sounds elicited by each of the recognizable objects according to said sequence of the recognizable objects;
determining the word of the spoken language based on said blending.

20. The method of claim 19, wherein said determining a sound to be elicited by each of said recognizable objects according to a predetermined set of rules including at least one of the following:
for an isolated object, the first sound of a word of the spoken language associated with said isolated object is the sound elicited by the object, and
for linked objects, the common sound of words of the spoken language associated with each linked object is the sound elicited by the linked objects.

21. A system for mutely communicating in a spoken language, comprising:
a memory configured to store data configured to facilitate mute communication in said spoken language;
a display screen configured to display recognizable objects used for mute communication in said spoken language; and
a processor configured to:
select a word of a language to communicate;
gathering a plurality of said recognizable objects each eliciting a sound of the word to be communicated; and
display the plurality of recognizable objects in an arrangement on the display screen such that at least one object corresponds to each sound of the word and the objects are arranged in a sequence that corresponds to a spoken sequence of the sounds of the word.

22. The system of claim 21, wherein said processor is configured to select by selecting a word from existing text stored in said memory to be mutely communicated using said system.

23. The system of claim 21, wherein said processor is configure to select selecting a word from audio speech stored in said memory to be mutely communicated using said system.

24. The system of claim 21, wherein said processor is configured to gather by gathering from memory a plurality of images each eliciting a sound of said word, and display said images on said display screen.

25. The system of claim 21, wherein said processor is configured to gather by gathering a plurality of objects from a predefined set of objects determined to represent substantially all sounds of the spoken language, said predefined set of objects being stored in said memory.

26. The system of claim 21, wherein said processor is configured to gather by gathering a plurality of objects each eliciting a sound of said word according to a predefined set of rules including at least one of the following:
for an isolated object, the first sound of a word of the spoken language associated with said isolated object is the sound elicited by the object, and
for linked objects, the common sound of words of the spoken language associated with each linked object is the sound elicited by the linked objects.

27. The system of claim 21, wherein said processor is configured to arrange by spatially arranging the objects on the display screen sequentially in a direction that the spoken language is textually written.

28. The system of claim 21, wherein said processor is further configured to determine an obscure sound and a common sound of the word.

29. The system of claim 28, wherein said processor is configured to arrange by linking more than one of said recognizable objects to represent said obscure sound, said linked objects having said obscure sound in common.

30. The system of claim 28, wherein processor is configured to determine an obscure sound by determining a sound that cannot be represented by the beginning sound of any recognizable object.

31. The system of claim 28, wherein said processor is configured to determine an obscure sound based on a predetermined set of sounds that have been defined as difficult to elicit by use of a recognizable object.

32. The system of claim 21, wherein said processor is configured to select a word by selecting a plurality of words to communicate a phrase of the language, said processor further configured to:
gather a plurality of recognizable objects each eliciting a sound of the phrase to be communicated; and
arranging the plurality of recognizable objects on the display screen such that at least one object corresponds to each sound of the phrase and the objects are arranged in a sequence that corresponds to the spoken sequence of sounds of the phrase.

33. The system of claim 32, wherein said processor arranges by arranging the plurality of objects in groups corresponding to each word of the phrase.

34. The system of claim 21, farther comprising at least one of the following:
a scanning device,
an optical character recognition engine,
a representation engine as described in claim,
a presentation engine as described in claim, and
a text to speech engine for sound output.

35. The method of claim 19, wherein said analyzing comprises analyzing an arrangement of recognizable objects organized in sequence on a display screen

36. A computer readable medium containing program instructions for execution on a computer system, which when executed by the computer system, cause the computer system to perform the steps in the method recited in any one of claims 1-18.

37. A system for mutely communicating in a spoken language, comprising:
means for selecting a word of a language to communicate;
means for gathering a plurality of recognizable objects each eliciting a sound of the word to be communicated; and
means for arranging the plurality of recognizable objects such that at least one object corresponds to each sound of the word and the objects are arranged in a sequence that corresponds to a spoken sequence of the sounds of the word.
